(19) United States
(12) Patent Application Publication
(10) Pub. No.: US 2011/0223405 A1
(43) Pub. Date: Sep. 15, 2011

(54) Composite polymer film with graphene nanosheets as highly effective barrier property enhancers

(75) Inventors: Owen C. Compton, Chicago, IL (US); SonBinh T. Nguyen, Evanston, IL (US)

(73) Assignee: Northwestern University

(21) Appl. No.: 12/931,406

(22) Filed: Jan. 31, 2011

Related U.S. Application Data
(63) Continuation-in-part of application No. 11/600,679, filed on Nov. 16, 2006, now Pat. No. 7,914,844.
(60) Provisional application No. 60/738,334, filed on Nov. 18, 2005.

(51) Int. Cl. C08K 5/29; C08L 25/06; C08K 3/04; B82Y 30/00

(52) U.S. Cl. 428/220; 524/577; 524/495; 524/197; 977/734

(57) ABSTRACT

Composite polymer films or layers have graphene-based nanosheets dispersed in the polymer for the reduction of gas permeability and light transmittance.

### RELATED APPLICATION

This application is a continuation-in-part of U.S. patent application Ser. No. 11/600,679 filed Nov. 16, 2006, which claims benefit and priority of U.S. provisional application Ser. No. 60/738,334 filed Nov. 18, 2006.

### CONTRACTUAL ORIGIN OF THE INVENTION

This invention was made with government support under Grant No. DMR-0520513 and CHE-0936924 awarded by the National Science Foundation. The government has certain rights in the invention.

### FIELD OF THE INVENTION

The present invention relates to composite polymer films or layers having graphene nanosheets dispersed as an additive in polymer for the reduction of gas permeability and light transmittance.

### BACKGROUND OF THE INVENTION

In modern society, polymer packaging plays a critical role in the preservation and distribution of perishable goods such as food and prescription medicines. Since the effectiveness of polymer packaging materials in preventing product degradation is directly dependent upon their impermeability to degradative gases and their opacity to high-energy light, significant efforts have been devoted to improving these properties.

Polymers such as polyethylene, polypropylene, poly(ethylene terephthalate), and polystyrene have become the packaging materials of choice in modern society due to their ability to preserve perishable products during transportation and storage at a fraction of the energy and materials costs associated with traditional materials such as wood, glass, ceramic, and metal. While polymers are light-weight, inexpensive, and easily processable, their performance is often limited by high gas permeability and transparency. As such, many polymer-based packaging materials are not made from one, but several components, allowing for both easy processing and enhanced barrier properties. However, the barrier properties of such films remain quite low in comparison to traditional materials, with ample room available for improvement, specifically in gas permeation.

A facile strategy for enhancing the barrier properties of a polymer is through the addition of a small amount of nanofiller, which reduces oxygen permeability while still maintaining the ease of processing of the parent polymer. In this context, polymer-clay nanonocomposites (PCNs), containing exfoliated clay nanosheets and stacks, have been studied for well over a decade due to promising improvements in their barrier properties over the parent polymer.^{[10, 11]} However, the hydrophilicity of the clay surface, along with difficulties in exfoliating clay aggregates during melt-state processing, has limited the range of possible PCNs as well as their utility.

Recently discovered polymer-graphene nanocomposites (PGNs), where graphene nanosheets can be chemically tailored to maximize their interaction with the polymer matrix to the point of complete dispersion are described in copending patent application Ser. No. 11/600,679 filed Nov. 16, 2006. PGNs can readily be prepared from virtually any polymer in a wide range of graphene loadings (0.02 to 40 volume %) using the appropriate derivatives of graphene, which in turn are easily obtained from inexpensive graphite powder.

### SUMMARY OF THE INVENTION

The present invention provides a composite polymer film or layer including graphene nanosheets for the reduction of gas permeability and light transmittance.

In an illustrative embodiment of the invention, at only 0.02 volume %, crumpled graphene nanosheets can significantly densify polystyrene films, thus lowering the free volume within the polymer matrix. This results in an unprecedented reduction in oxygen solubility, nearly three-orders-of-magnitude greater than the value predicted by the rule of mixtures (ROM), which further manifests as a considerable decrease in oxygen permeability. Also, the light transmittance at 350 nm wavelength of an approximately 0.25 mm thick polystyrene film can be reduced from 94% to 31% by inclusion of the graphene nanosheets. At such low concentration, crumpled graphene sheets are as effective as clay-based nanofillers at approximately 25-130 times higher loadings. Given these characteristics, polymer films or layers including a low concentrations of graphene nanosheets offers a simple, inexpensive means to significantly enhance the barrier properties of polymer-based packaging materials for air- and light-sensitive products.

Packaging materials comprising the composite film or layer (polymer-graphene nanosheets) have the potential to greatly increase the shelf life of perishable goods. Since graphene nanosheets can serve as a nanofiller for other polymers, including those that cannot be dissolved in solvent at room temperature and require co-processing with other polymers for dispersion, polymer-graphene nanocomposites can find wide use as packaging materials.

These and other advantages will become more apparent from the following detailed description taken with the following drawings.

### BRIEF DESCRIPTION OF THE DRAWINGS

FIG. 1(a)—relative permeability plots for films of polystyrene-graphene (represented as PGN) and polystyrene-montmorillonite (represented as PCN) in comparison to a pristine polystyrene film. Predicted values from modified-Nielsen and Cussler theories (calculated assuming aspect ratio α=500) are also included for comparison. FIG. 1(b)—example data sets for diffusion measurements showing oxygen transmission rates for degassed polystyrene-graphene films after exposure to oxygen (flow rate=20 mL min⁻¹). FIG. 1(c) and FIG. 1 (d)—schematic representations of oxygen molecules following a tortuous path through a PGN with sheets arranged according to the modified-Nielsen and Cussler models, respectively. The fading of the “planks” in the Cussler model is intended to indicate their infinite extension into the alignment direction.

FIG. 2 (a)—digital image of ˜0.028-cm-thick polystyrene-graphene film strips with increasing graphene volume % loading (values noted either at the top or bottom of the strips) demonstrating the wide range of transparency possible. FIG. 2(b)—transmittance spectra of polystyrene films (0.028±0.001 cm thick) illustrating the decreasing transparency with increased graphene loadings.

FIG. 3 (a)—SEM image of a polystyrene-graphene thin film (0.47 volume % loading) illustrating the crumpled morphology of graphene sheets and their complete dispersion within the polymer matrix. Given the random orientation and overlapping nature of graphene sheets within the matrix, this figure should not be used in the determination of nanosheet dimensions or degrees of exfoliation. FIG. 3(b)—digital image of a 0.027-cm-thick polystyrene-graphene film (0.24 volume % loading) being bent, thus demonstrating its flexibility. FIG. 3 (c)—TEM image of phenyl isocyanate-modified graphene nanosheets illustrating representative lateral sheet dimensions and wrinkled morphology.

FIG. 4(a)—relative diffusion coefficients and FIG. 4(b)—relative solubility coefficients for hot-pressed polystyrene-graphene thin films in comparison to that for a pristine polystyrene film. Inset: Plot of the densities for spin-cast polystyrene-graphene thin films as obtained from refractive index measurements at 632.8 nm. Dashed lines are included only as visual guides.

### DETAILED DESCRIPTION OF THE INVENTION

The present invention employs the polymer-graphene nanosheet composite materials described in copending patent application Ser. No. 11/600,679 filed Nov. 16, 2006, which is incorporated herein by reference, wherein mixing a dispersion of exfoliated phenyl isocyanate-treated graphene oxide sheets in a polar aprotic solvent (e.g., DMF) with polystyrene (or other liquid polymers) followed by chemical reduction of the phenyl isocyanate-treated graphite oxide sheets in-situ in the polymer forms a composite comprising individual, reduced graphene nanosheets dispersed throughout the polymer matrix. As the reduction process proceeds, the individual graphene nanosheets become coated with the polymer and remain individually dispersed in the polymer matrix without harmful agglomeration. Even with very small loadings of the graphene nanosheet component (e.g., 0.1 volume %), a dense network of “fully solvated”, overlapping graphene sheets can be observed within the polymer matrix, producing a uniformly opaque film. Example 3 of Ser. No. 11/600,679 provides details of an illustrative embodiment wherein exfoliated phenyl isocyanate-treated graphene oxide sheets in DMF are mixed with polystyrene (or other polymers mentioned) followed by chemical reduction of the phenyl isocyanate-treated graphene oxide sheets in-situ in the polymer using dimethylhydrazine to form a composite powder material, which was hot pressed to form test strips of 0.3-0.5 mm thickness. Samples were produced having a content of graphene nanosheets of 0.24, 1.44, and 2.4 volume % in the composite material.

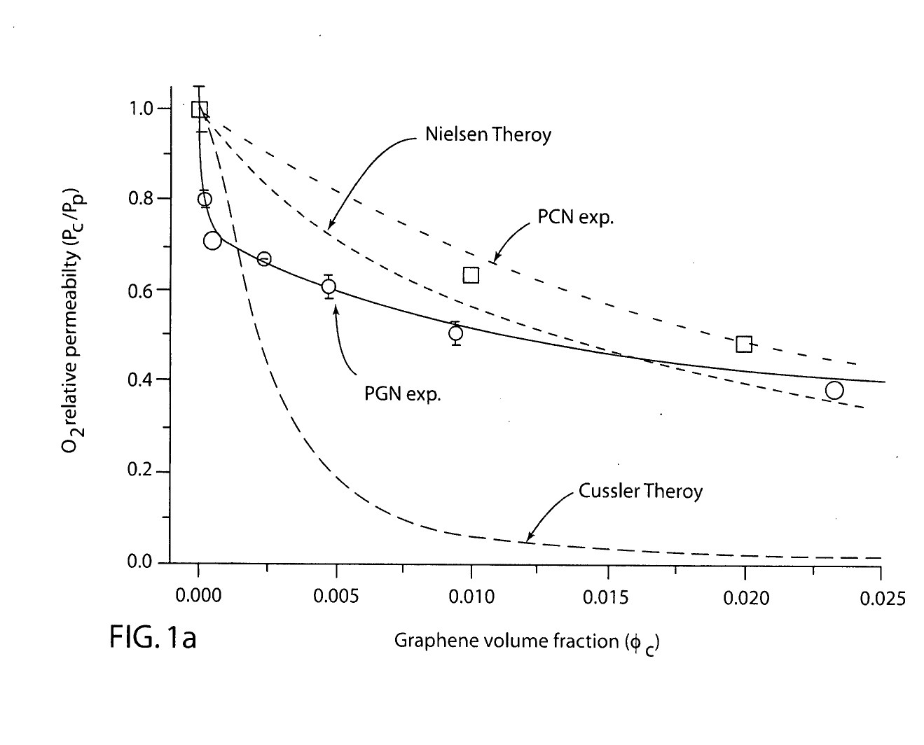

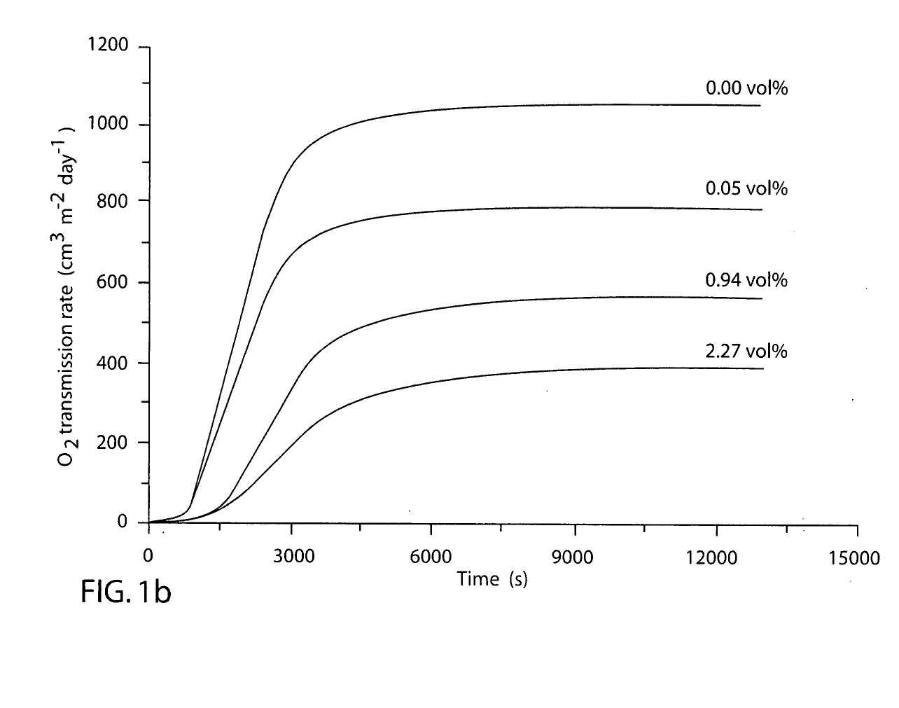

The present invention relates to the discovery of the exceptional ability of the graphene-based composite materials of the type described in copending patent application Ser. No. 11/600,679 filed Nov. 16, 2006, to be formed into films or layers, or for graphene-based materials, such as individual graphene nanosheets or stacks of such nanosheets, to act as a nanofiller in films or layers, wherein the graphene nanosheets limit both oxygen (gas) permeation and light transmission in the polymer films or layers. These beneficial properties are achieved even at relatively low concentrations of the graphene nanosheets in the polymer film or layer. For example, a relatively low concentration from 0.01 to 0.1 volume % of graphene nanosheets can significantly densify polystyrene and other polymer films, thus lowering the free volume within the polymer matrix, although the graphene nanosheets can be present in an amount of about 0.01 volume % to about 40 volume % within the invention. The individual graphene nanosheet, or stack of graphene nanosheets, can have a thickness dimension of about 0.4 to about 1 nm. Inclusion of the graphene nanosheets results in an unprecedented reduction in oxygen solubility, nearly three-orders-of-magnitude greater than the value predicted by the rule of mixtures (ROM), which further manifests as a considerable decrease in oxygen permeability. Also, the light transmittance can be significantly reduced as well. The films or layers pursuant to the invention serve as excellent barrier materials for light and reactive gases, such as O₂, where the diffusing gas molecule would encounter a tortuous path in traversing the film or layer (see FIG. 1c and 1d).

The composite polymer-graphene nanosheet nanocomposite films or layers (PGN films or layers) can include thin films, layers, coatings, thin boards, laminates, and sealants having reduced gas permeation and light transmittance and can have a thickness of 0.1 to about 50 mm for purposes of illustration and not limitation.

Since graphene nanosheets can serve as a nanofiller in other polymers, including those that cannot be dissolved in solvent at room temperature and require co-processing with other polymers for dispersion, polymer matrix-graphene nanosheet composite materials can find wide use as packaging materials. The invention envisions using graphene nanosheets, made by the processing methods described in Ser. No. 11/600,679 or by other different processing methods, as a nanofiller in any of a wide variety of polymer matrices to reduce the gas permeability and light transmittance of the resulting composite polymer matrix-graphene nanosheet film or layer.

Composite films or layers of the type described above comprising the polymer matrix with dispersed graphene nanosheets have the potential to greatly increase the shelf life of perishable goods and products including, but not limited to, foodstuffs and pharmaceuticals such as vitamins, drugs, as well as orthopedic implants.

The graphene nanosheets can be surface-functionalized to express alkyl, substituted alkyl, phenyl, aryl, substituted phenyl, substituted aryl, and combinations of the moieties. These surface functional groups can also be modified with a wide range of other common organic functional groups to provide the necessary compatibility with the polymer matrix, which can be selected from the group consisting of polystyrene, polyacrylates, polyolefins, functionalized polyolefins (such as poly(vinyl chloride), poly(vinyl acetate), poly(vinyl alcohol), polyacrylonitriles), polyesters, polyurethanes, and polyethers.

To this end, the effect of graphene nanofillers to reduce both light transmittance and oxygen permeability properties integral to the lifetime of product storage, in the common food packaging material polystyrene was investigated as described in the Example below.

### EXAMPLE

### Experimental

Nanocomposite Thin Film Fabrication: Graphite powder (SP-1, Bay Carbon) was converted to graphite oxide following a modified Hummers method described in Ser. No. 11/600,679 and by Hummers, W. S., Offeman, R. E., J. Am. Chem. Soc., 1958, 80, 1339-1339, and by Kovtyukhova, N. L., Olliver, P. J., Martin, B. R., Mallouk, T. E., Chizhik, S. A., Buzaneva, E. V., Gorchinskiy, A. D., Chem. Mater. 1999, 11, 771-778, the disclosures of which are incorporated herein by reference, and then was then dried in a vacuum desiccator for a week. This dried graphite oxide was then functionalized with phenyl isocyanate (Aldrich Chemicals) according to procedures as described in Ser. No. 11/600,679 and by Stankovich, S., Piner, R. D., Nguyen, R. S., Ruoff, R. S., Carbon 2006, 44, 3342-3347, the disclosures of which are incorporated herein by reference, and dried in a vacuum desiccator for at least a week before further processing. Polymer-graphene nanocomposites (PGNs) were prepared from the phenyl isocyanate-treated graphene oxide as described in Ser. No. 11/600,679 and by Stankovich, S. et al. Nature 2006, 442, 282-286, the disclosures of which are incorporated herein by reference. After drying in a vacuum oven at 90° C. for 18 h, the composite powder was pressed into a pellet using a hand-operated hydraulic press, hot-pressed into a thin film (7,000 N cm⁻² @ 130° C. for 1 h), and cold-pressed for 1 h with pressure held constant.

In particular, two grams of graphite powder was converted to graphite oxide following a modified Hummers method and then dried in a vacuum desiccator for a week before further reaction. This dried graphite oxide was then functionalized with phenyl isocyanate and dried in a vacuum desiccator for at least a week before further reaction. Dried, phenyl isocyanate-treated graphite oxide (0.7-70.0 mg to maintain a ratio of 0.02 to 2.27 volume % to polystyrene, see weight % to volume % calculation below) was dispersed in DMF (5-10 mL) by sonication for 15 min (Fisher Scientific FS60, 150 W). Concurrently, polystyrene (700-1400 mg) was dissolved in DMF (10-15 mL) at 90° C. with vigorous stirring. The phenyl isocyanate-treated graphene oxide dispersion was then added to the polystyrene solution and allowed to mix for 5 min before addition of 1,1-dimethylhydrazine (10 molar excess with respect to the modified graphene oxide). Reduction by 1,1-dimethylhydrazine was carried out at 90° C. for 18 h, during which the solution turned from brown to black, indicating conversion to graphene. The hot nanocomposite solution was then added dropwise to room-temperature methanol (200-400 mL) with stirring. The precipitated product was isolated by filtration and washed with methanol (two 50-mL aliquots) before drying in a vacuum oven (Fisher Scientific 280A) at 90° C. for 18 h.

All chemicals were received from Aldrich Chemicals (Milwaukee, Wis.) unless otherwise noted. SP-1 graphite powder was obtained from Bay Carbon (Bay City, Mich.). Atactic polystyrene beads (MW=280,000, PDI=3.0) were received from Scientific Polymer. Products, Inc. (Ontario, N.Y.). N,N-dimethylformamide (DMF, 99.8%) was used as received. Phenyl isocyanate (98+%) was stored under nitrogen. 1,1-Dimethylhydrazine (98%) was stored under nitrogen at 6° C.

Conversion to volume %: All samples were initially prepared according to wt % of phenyl-isocyanate functionalized graphene sheets and polystyrene. These weight % values were converted to volume % percent assuming a 2.2 g cm⁻³ density for phenyl isocyanate-treated graphene and the known 1.05 g cm⁻³ density for polystyrene.

Permeability Measurement: Nanocomposite films were masked with an adhesive aluminum film to expose a circular 5 cm² surface area. Film samples were loaded into an OX-TRAN 2/21 MH (MOCON, Inc.) instrument for measurement of oxygen transmission rate following American Society for Testing and Materials (ASTM) protocol D3958.

PGN Thin Film Fabrication for Permeability Testing: After drying, the composite powder was pressed under vacuum at 11,000 N cm⁻² into a 3.175-cm-diameter disc using a hand-operated hydraulic pump (SPEX SamplePrep, LLC., Metuchen, N.J.). The disc was then placed between two brass plates (˜0.65-cm thick) separated by two thin pieces of copper (˜0.027-cm thick), serving as spacers. A Kapton® polyimide film (Argon Masking, Inc., CA), resistant to heat degradation up to 400° C., was placed between the disc and each brass plate to prevent adhesion after hot-pressing. In this configuration, the disc was compressed into a thin film by a hydraulic press (Carver AutoFour/30, P Type, Carver, Inc., Wabash, Ind.) at 130° C. and 7,000 N cm⁻² for 1 h, then cold-pressed at that same pressure for an additional hour after the platens were cooled to room temperature with circulating water. Dispersion of phenyl isocyanate-functionalized graphene within the polymer matrix was confirmed by XRD. Since a minimum of four PGN films were prepared for each permeability measurement, any inconsistencies in the multi-step processing of each film would contribute to variance in the average reported permeability value (Table 1-Appendix). We note that variation in the graphene content is not likely a contributing factor to such variance as PGN films with graphene loadings of 0.02 and 0.94 volume % both yielded permeability values with similar absolute deviations. We also note that the polystyrene comprising the polymer matrix is atactic and thus amorphous, precluding any affect of polymer crystallinity on the permeability measurements.

PGN Film Density Measurement: The density of polystyrene and GPNs thin films were calculated from refractive index measurements, which were collected via ellipsometry with an M-2000D Ellipsometer (J. A. Woolam Co., Inc., Lincoln, Nebr.). Films were spin-cast from a mixture of DMF and toluene (1:5 v/v) to thicknesses ranging from 200 to 450 nm.

PGN Thin Film Fabrication for Density Measurements: The precipitated polystyrene-graphene nanocomposites (100 mg), prepared as described above, were dissolved in DMF (0.5 mL) and diluted with toluene (1:5 v/v). A small amount (˜0.25 mL) of the resulting nanocomposite solution was deposited onto a silicon wafer (Si(100), P-type, test grade, thickness 475-575 μm, WaferNet, Inc., San Jose, Calif.), and the substrate was rotated at 2,000 rpm using a research photo-resist spinner (model #PWM101-PMCB15, Headway Research, Inc., Garland, Tex.) with additional nanocomposite solution being added drop-wise to the rotating wafer until a discernable color change from metallic grey to blue was observed. The spin-cast films were then annealed overnight at 120° C. to preclude variations in refractive index measurement arising from inconsistent thicknesses between samples.

Cussler and Nielsen Models for gas permeation: Among the many models available for gas permeation through a barrier material, we employed the modified Nielsen model at all nanofiller concentrations as it assumes randomly oriented disks in a polymer matrix, which is the closest description available for our crumpled graphene sheets. However, we realized that this model may underestimate the efficacy of the nanofiller. As such, we also employ the Cussler model, which typically overestimates the effect of nanofiller on gas permeability. However, the experimental results obtained exceed the predictions by both of these models as will be apparent below.

### Test Results:

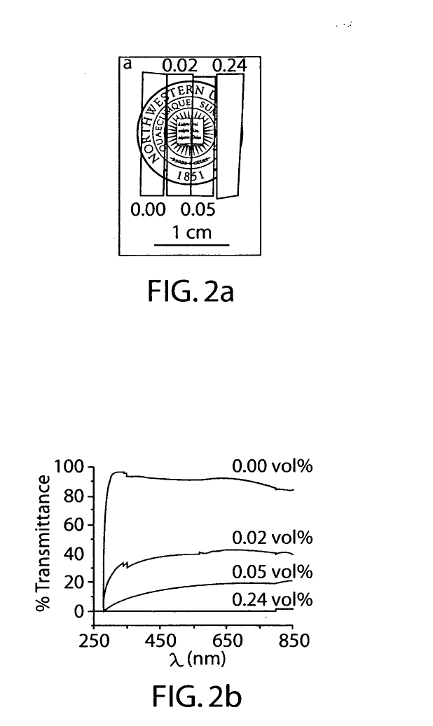

In general, the test results showed that the PGN films made of composite polystyrene-graphene nanosheet films with graphene loading as low as 0.02 volume %, both decrease light transmission by >50% throughout the UV-visible spectrum (FIGS. 2a, 2b) and are superior in reducing the relative O₂ permeability of polystyrene to some of the best reported PCNs at ˜40 times more nanofiller loading (FIG. 1a) (see Yeh, J.-M. et al. Surf. Coat. Technol. 2006, 200, 2753-2763, the disclosure of which is incorporated herein by reference).

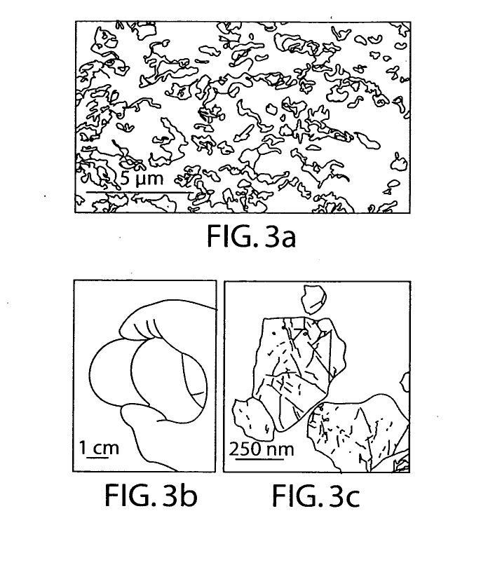

Montmorillonite (MMT), the most commonly used clay in polymer clay nanocompsites (PCNs) can be delaminated into 1-nm-thick two-dimensional nanosheets ˜200 nm in length in the presence of a polymer. However, incomplete delamination of clay layers during the preparation of PCNs often results in thick aggregates with significantly lower aspect ratios (˜2-28). In contrast, not only are phenyl isocyanate-functionalized graphene sheets routinely obtained as individual sheets ˜1 nm thick and typically ˜500 nm in length (˜500 aspect ratio, FIG. 3c), they do not agglomerate when processed into nanocomposites.

At the lowest tested concentration of graphene nanosheets (0.02 volume %, or 0.5 mg per gram of polystyrene), the oxygen permeability of the PGN thin films is 80% that of pristine polystyrene (4.75±0.2 Barrer, see also FIG. 1a and Table 1-Appendix). While the permeability for PCNs is nearly indistinguishable from that of the pristine polymers at such low concentrations, comparable reductions in permeability can be reached with highly-exfoliated MMT in a variety of polymers, but only at much higher loadings (1.0 to 1.5 volume %). The permeability of PGNs films of the invention at 0.02 volume % would be more than an order of magnitude lower than the experimental results expected for comparably loaded PCNs along the modified-Nielsen and Cussler trend lines. Interestingly, the barrier effectiveness of our PGN films is highest at loadings lower than 0.94 volume % (FIG. 1a); at higher loadings our exhibited permeability coefficients become closer to that of the predicted Nielsen value. However, the permeability coefficient at 0.94 volume % is still 50% lower than that of pristine polystyrene and nearly two times better than PCNs at similar loadings.

The permeability coefficient (P) is dependent upon the solubility (S) and diffusion (D) coefficients of a gas in a polymer film and can be expressed as P═S×D (an explanation of coefficient units is provided in the Appendix). The addition of graphene sheets to a pristine polymer would reduce gas solubility, due to the insolubility of gas in the nanosheets, and diffusivity, as the gas molecules must maneuver around the newly introduced impermeable two-dimensional nanofiller to diffuse through the polymer (FIGS. 1c and 1d). While a change in gas solubility is normally considered to be only dependent upon the concentration of the nanofiller (φ_{c}), diffusivity is also affected by the aspect ratio (α) of the two-dimensional barriers. Both parameters can be incorporated into a modified-Nielsen model (equation 1) (Nielson, L. E., J. Macromol. Sci., Part A: Pure Appl. Chem. 1967, 1, 929-942 and Choudalakis, A. D., et al., Eur. Polym. J., 2009, 45, 967-984), the disclosures of which are incorporated herein by reference, which has been shown to be most accurate in predicting relative permeability coefficients in nanocomposites having randomly distributed nanofillers with high aspect ratio and at low concentrations, as in the case of our PGNs. The permeability coefficient of our PGNs at low (≦0.05 volume %) loadings was surprisingly much lower than anticipated when compared to values predicted by equation 1 (more than 10 times lower at 0.02 volume % loading). Measured values become more similar (within 15%) to those predicted by the modified-Nielsen theory at higher loadings (0.47 to 2.27 volume %) and closely mirror the trendline with increased volume % (FIG. 1a).

$$\frac{{P}_{c}}{{P}_{m}} = \frac{1 - {φ}_{c}}{1 + ( \frac{1}{3} ) \frac{α}{2} {φ}_{c}} \qquad ( 1 )$$

Because the modified-Nielsen model was developed for rigid two-dimensional nanofillers with limited interactions between the nanofiller and the polymer, it may not apply well to the crumpled graphene sheets in our PGN films. When embedded in polystyrene, the as-prepared two-dimensional graphene nanosheets (FIG. 3c) would crumple (FIG. 3a), resulting in additional interactions with the pendant phenyl groups of polystyrene and improved barrier properties (see below). For example, at 0.02 volume % loading of graphene, the modified-Nielsen model would require the two-dimensional graphene sheets to have an aspect ratio ˜6000 to reach our experimentally observed permeability value. However, from TEM measurements (FIG. 3c) we can only assign an average aspect ratio of ˜500 to flattened out graphene sheets, which is artificially large—upon dispersion inside the polymer matrix, the lateral dimensions and effective aspect ratios of the crumpling sheets would certainly decrease. Given the aforementioned large discrepancy in Nielsen-predicted behavior vs. experimental results, we also compared our data to the Cussler model (equation 2) (Cussler, E. L, et al. J. Membr. Sci., 1988, 38, 161-174, the disclosure of which is incorporated herein by reference), which assumes a well-ordered stacked array of nanoplatelets that extend through the entire polymer film (FIG. 1d) and over-estimates the effect of nanofiller materials in permeability reduction at low nanofiller concentrations. Still, the PGN permeability coefficient at 0.02 volume % loading was nearly more than 14 times lower than the Cussler-predicted values (FIG. 1a). Given that the graphene sheets in our PGNs are not well-ordered up to 0.47 volume %, it is clear that a reduction in diffusivity alone does not explain the high barrier-effectiveness for our PGN films at low loadings.

$$\frac{{P}_{c}}{{P}_{m}} = {( 1 + \frac{{α}^{2} {φ}_{c}^{2}}{1 - {φ}_{c}} )}^{- 1} \qquad ( 2 )$$

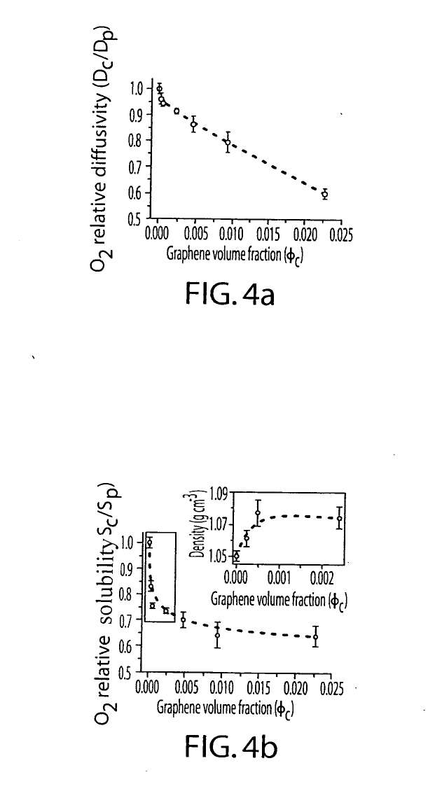

The dependence of D (FIG. 4a) on the volume fraction of graphene is surprisingly different from that of S (FIG. 4b). For our PGN films, D decreases linearly by 40% over the range of 0.02-2.27 volume % loading, while the value of S drops by nearly 17% within the first 0.02 volume % loading and levels off at a 35% decrease as the graphene loading is increased up to 2.27 vol %. While the effect from D is not negligible at a loading of 0.02 volume %, the largest contribution to the unexpectedly low permeability coefficients of the PGN films at these loadings was the low solubility of O₂. With further addition of graphene, especially above 0.05 volume %, diffusion effects become an increasingly important factor in determining the change in permeability of our PGNs.

Although not wishing to be bound by any theory, the unprecedented decrease in O₂ solubility for the PGN films pursuant to the invention at low graphene concentrations appear to be attributed to the unique crumpled morphology (FIG. 3a) of the phenyl isocyanate-modified graphene nanosheets, their large surface areas (theoretically up to 2,600 m² g⁻¹), and high levels of interaction with the polystyrene matrix. At low concentrations, polymer chains can interact fully with the graphene sheets, allowing for the sheets to become completely “wetted” by the polymer chains, thereby densifying the polymer matrix. Decreases in S for nanocomposites with good polymer/nanofiller interaction are typically described by equation 3, where Sₘ is the solubility of the gas in the parent polymer. However, this equation, which clearly does not accurately describe the composite of the invention, does not take into account either the morphology of the nanofiller or the extent of polymer/nanofiller interaction.

S_{c}=Sₘ(1−φ_{c}) (3)

Lamellar clay nanosheets are known to have poor interactions with hydrophobic polymer matrices as signified by their incomplete exfoliation during PCN processing. In sharp contrast, the sp²-hybridized surface of our graphene nanosheets, along with the phenyl moieties of the surface-bound isocyanate groups, may engage in π-π interactions with the pendant phenyl groups of polystyrene, similar to those observed between pyrene and graphene, although applicants do not wish to be bound by any theory in this regard. Such interactions, facilitated by the crumpling of the graphene nanosheets when dispersed within the polymer matrix, would allow for excellent exfoliation and “wetting” of these sheets. This would limit the formation of interstitial cavities, or free volume, between the polymer chains in the matrix during PGN fabrication and may create a denser polymer matrix. Because the presence of such cavities increases gas permeability and solubility, preventing their formation could account for the marked decrease of O₂ solubility in the PGN films (nearly three orders of magnitude lower than the value predicted by the ROM at 0.02 volume % loading). Such an effect is evidenced by the relatively large increase in the density of 200- to 450-nm-thick spin-cast PGN films: PGN films with only 0.02 volume % loading of graphene nanosheets are 1.050% denser than those of pure polystyrene (FIG. 4b inset, density calculation from refractive index measurements).

The increase (1.050%) in density for our PGN film at near-trace (0.02 volume %) graphene nanosheet loadings is particularly significant when one considers the exponential relation between the free volume of the polymer matrix, which decreases dramatically with small increases in density, and permeability in equation 4, where A and B are constants and f is the fractional free volume of the polymer membrane. For comparison, poly(methyl methacrylate)-MMT composites containing 1.3 and 2.7 volume % of clay nanofiller only exhibit densifications of 0.63 and 1.37%, respectively, according to the ROM (Manninen, A. R., et al. Polym. Eng. Sci. 2005, 45, 904-914, the disclosure of which is incorporated herein by reference).

P=Ae^{-B/f} (4)

At the lowest tested graphene sheet concentration (0.02 volume %), the change in density of our PGN film (from 1.050 g cm⁻³ for neat PS to 1.061 g cm⁻³ for the PGN) is over 40 times greater than expected from ROM; however, this effect levels off with additional graphene loading—at 0.24-volume % graphene loading, the increase in density to 1.074 g cm⁻³ for the PGN film is only 9 times greater than expected from ROM. This trend is similar to that observed for S (see above) where decreases in O₂ solubility are prominent at low nanofiller loading, but further decreases are quickly mitigated at higher graphene concentrations. That decreases in S correlate well with increases in the density of our PGNs suggests that the changes in both of these properties originate from the same free volume reduction.

While decreasing the gas permeability of polymer-based packaging materials can lead to tremendous improvements in the shelf life of packaged perishable goods, the shelf lives of many foods can be further extended if kept out of light, typically at wavelengths 500 nm. In this context, PGN films of the invention also exhibit impressive properties, being fully tunable from semi-transparency to opacity simply by varying graphene loading (FIG. 2a). PGN films ˜0.28-mm thick transmit only 40% of 500-nm light at 0.02-volume % loading, and become fully opaque at concentrations as low as 0.24 volume % (FIG. 2b). Such significant decreases in transmittance are likely due to the good dispersion of graphene within the polymer matrix, along with its high surface area, both of which lead to highly effective scattering of incident light. By restricting all light in the visible and UV spectrum and significantly reducing gas permeability, PGN films are ideal for packaging air- and light-sensitive products such as vitamins, wines, and ales.

Calculation of the advantageous effects that polystyrene-graphene films may have in protecting orange juice: To place the advantage of the decreased P values afforded by PGN-based packaging materials in perspective, we estimate the stability of ascorbic acid in orange juice that is stored in a bottle capped with a polystyrene-graphene film. A study by Svanberg and coworkers (O, Solomon, U. Svanberg, A. Sahlström, Food Chem. 1995, 53, 363-368.) found a strong inverse correlation between ascorbic acid concentration in orange juice and the concentration of dissolved oxygen. In their work, an orange juice sample stored in a glass bottle capped with a thin polyethylene film showed an ascorbic acid half-life of ˜22 days. Given the close proximity of P for polystyrene (2.5) and polyethylene (2.9) (S. Pauly, in Polymer Handbook (Eds: J. Brandrup, E. H. Immergut), Wiley-Interscience, New York 1989, VI/435-499), we assume a pristine polystyrene cap would give a similar half-life. Since the autoxidation of ascorbic acid is first-order with respect to oxygen (M. H. Eison-Perchonok, T. W. Downes, J. Food Sci. 1982, 47, 765-767), relative decreases in permeability would directly relate to increases in ascorbic acid half-life. Thus, a cap made from polystyrene-graphene at 0.02 volume % loading would increase ascorbic acid half-life to ˜27 days and one at 2.27 volume % loading would almost double the half-life (˜35 days). Such increased protection of quality would significantly raise the shelf-life of perishable goods and allow for extended storage of air-sensitive products.

The above Example has demonstrated that the crumpled morphology of graphene nanosheets, along with their facile chemical tunability, allows for the fabrication of PGN films with low O₂ permeability and effective reduction of transparency. Good interaction between graphene sheets and polymer promotes full dispersion and is responsible for these highly desirable packaging properties, making PGN films much more effective than PCN films. As such, polystyrene-graphene nanocomposites have excellent potential far beyond polystyrene as packaging materials that can greatly increase the shelf life of perishable goods. Since crumpled graphene nanosheets can serve as a nanofiller for other polymers, including those that cannot be dissolved in solvent at room temperature and require co-processing with other polymers for dispersion, PGNs of the invention can see wider use as packaging materials. In particular, the PGN-based films or layers can be commercially mass-produced as rolls or large sheets by extrusion, molding, or hot-pressing.

### APPENDIX

### Measurement of O₂ Transmission Rates and Calculations of P, D, S Coefficients and Densities

Explanation of Coefficient Units: Units for reporting permeability, diffusion, and solubility coefficients (P, D, and S, respectively) vary widely in the literature. While data are best understood as relative values with respect to a pristine polymer, we provide here an explanation of the reported units in this patent application.

Permeability coefficient (P) values are presented in Barrer (S. A. Stern, J. Polym. Sci., Part A-2: Polym. Phys. 1968, 6, 1933-1934, the disclosure of which is incorporated herein by reference). This unit is not included in the International System of Units, but has the value of 1 Barrer=10⁻¹⁰ cm³ cm cm⁻² s⁻¹ cmHg⁻¹. From left to right, these units correspond to: 1) cm³ is the unit for the molar volume of O₂, at standard temperature and pressure (STP), that passed through the film during measurement; 2) cm is the unit for the thickness of the nanocomposite film; 3) cm⁻² is the unit for the reciprocal of the film's exposed surface area; 4) s⁻¹ is the unit for the reciprocal of time elapsed during measurement; and 5) cmHg⁻¹ is the unit for the reciprocal of pressure gradient across the membrane.

Units for the diffusion coefficient (D) are cm² s⁻¹. From left to right, these units correspond to: 1) cm² is the unit for the square of the thickness of the nanocomposite film; and 2) s⁻¹ is the unit for the reciprocal of half the time required for the transmission rate of O₂ to equilibrate after exposure to a degassed film.

The solubility coefficient (S) has units of cm³ cm⁻³ atm⁻¹. From left to right, these units correspond to: 1) cm³ is the unit for the molar volume of O₂ at STP that is soluble in the nanocomposite film; 2) cm⁻³ is the unit for the reciprocal of the volume of the exposed nanocomposite film; and 3) atm⁻¹ is the unit for the reciprocal of pressure across the membrane.

Oxygen Transmission Rate Measurement: Oxygen transmission rates (OTRs) were collected at 23° C. and 0% relative humidity using an OX-TRAN model 2/21 MH OTR tester (MOCON Inc., Minneapolis, Minn.) following American Society for Testing and Materials (ASTM) protocol D3958. Samples were conditioned in a N₂:H₂ (98:2 v/v) atmosphere, which also served as the carrier gas, for 2 h before testing. The carrier gas was circulated at flow rate of 10 mL min⁻¹ and films were exposed to oxygen at a rate of 20 mL min⁻¹. All permeability coefficient values (see calculation below) are averaged from at least four separate films and diffusion coefficient values are averaged from at least two separate films.

The edge of the circular nanocomposite films were cut into a hexagonal shape using scissors and the thickness of each edge was measured using electronic calipers (SPI, resolution 0.01 mm). Nanocomposite films with thicknesses ranging from 0.027 to 0.028 cm were masked with adhesive aluminum foil (MOCON, part no. 025-493) to a surface area of 5 cm². Mask edges were coated with a thin layer of Apiezon® grease (type T, M&I Materials Ltd., Manchester, UK) before loading into the instrument to ensure an air-tight seal before testing.

Calculation of P, D, and S Coefficients. Equilibrium OTRs reported in cm³ m⁻² day⁻¹ were converted into cm³ cm⁻² s⁻¹ before calculation of permeability coefficient according to equation S1.

$$P = \frac{O T R \cdot cm}{cmHg} \qquad ( S1 )$$

Here cm is the film thickness and cmHg is the unit for the pressure gradient across the membrane.

Diffusion measurements were made under the same conditions as described for permeability measurements but after fully degassing the PGN films. Diffusion coefficients were calculated via the “half-time” method using equation S2 (K. D. Ziegel, H. K. Frensdorft, D. E. Blair, J. Polym. Sci., Part A-2: Polym. Phys. 1969, 7, 809-819, the disclosure of which is incorporated herein by reference).

$$D = \frac{{cm}^{2}}{7.199 \cdot {t}_{1 / 2}} . \qquad ( S2 )$$

Here cm² is the unit for the square of the film thickness and t_{1/2} (in seconds) is half of the time required to reach equilibrium OTR.

The solubility coefficient was calculated according equation S3.

$$S = \frac{P}{D} \qquad ( S3 )$$

TABLE 1
O₂ transmission coefficient values [a] and densities

| | | Diffusivity | Solubility | |
|---|---|---|---|---|
| Graphene | Permeability | (D) | (S) (cm³ | Film |
| Content | (P) | (cm² s⁻¹) | (STP) cm⁻³ | Density |
| (φ_{c}) | (Barrer) | (10⁻⁷) | atm⁻¹) (10⁻²) | (g cm⁻³) |
| 0.0000 [b] | 4.75 ± 0.05 [b] | 7.15 ± 0.02 | 6.65 ± 0.02 | 1.050 ± 0.003 |
| 0.0002 | 3.80 ± 0.09 | 6.86 ± 0.02 | 5.54 ± 0.02 | 1.061 ± 0.005 |
| 0.0005 | 3.39 ± 0.03 | 6.74 ± 0.01 | 5.03 ± 0.01 | 1.077 ± 0.008 |
| 0.0024 | 3.20 ± 0.04 | 6.53 ± 0.01 | 4.90 ± 0.01 | 1.074 ± 0.007 |
| 0.0047 | 2.88 ± 0.13 | 6.17 ± 0.03 | 4.67 ± 0.03 | NA [c] |
| 0.0094 | 2.44 ± 0.12 | 5.69 ± 0.04 | 4.29 ± 0.05 | NA [c] |
| 0.0227 | 1.84 ± 0.02 | 4.30 ± 0.02 | 4.28 ± 0.04 | NA [c] |

[a] The thicknesses of all films tested for P, S, and D coefficients were 0.028 ± 0.001 cm.
[b] Our experimental value for the permeability coefficient of pristine polystyrene is similar to those previously reported in literature (S. Nazarenko, P. Meneghetti, P. Julmon, B. G. Olson, S. Qutubuddin, J. Polym. Sci., Part B: Polym. Phys. 2007, 45, 1733-1753).
[c] Density values for polystyrene-graphene nanocomposite samples with graphene loading above 0.25 vol % could not be measured.

Calculation of density from refractive index measurements. The density of a film (ρ) can be calculated from the refractive index of that film according to a modified Lorentz-Lorenz equation S4 (J. C. Seferis, in Polymer Handbook (Eds: J. Bandrup, E. H. Immergut), Wiley-Interscience, New York 1989, VI/451-453, the disclosure of which is incorporated herein by reference).

$$ρ = \frac{( {n}^{2} - 1 )}{( {n}^{2} + 2 ) \cdot C} \qquad ( S4 )$$

Here n is the measured refractive index and C is a constant calculated from the known density (1.05 g cm⁻³) of the pristine polystyrene film. The value for C in our system was 0.3199 cm³ g⁻¹ and its components are shown in equation S5.

$$C = \frac{{N}_{A} α}{3 {M}_{0} {ɛ}_{0}} \qquad ( S5 )$$

Here N_{A} is Avagadro's number, α is the average polarizability of the polymer repeat unit, M₀ is the molecular weight of the polymer repeat unit, and ε₀ is the permittivity of free space constant. Since these values are constant for pristine polystyrene films and those containing graphene nanofiller, we did not calculate individual values or equate units.

Theoretical density can then be determined by the rule of mixtures (ROM) equation S6.

ρ=(ρ_{c}·φ_{c})+(ρₘ·φₘ) (S6)

Here ρ_{c} and ρₘ are the densities of phenyl isocyanate-modified graphene (2.2 g cm⁻³) and polystyrene (1.05 g cm⁻³), respectively, (Stankovich, S, et al., Nature 2006, 442, 282-286, the disclosure of which is incorporated herein by reference). The volume fractions of the nanofiller and polymer matrix are represented by φ_{c} and φₘ, respectively.

Although the invention has been described in connection with certain embodiments thereof, those skilled in the art will appreciate that changes and modifications can be made therein within the scope of the invention as set forth in the appended claims.

References which are incorporated herein by reference:
[1] Hummers, W. S., Offeman, R. E., J. Am. Chem. Soc., 1958, 80, 1339-1339.
[2] Kovtyukhova, N. L., Olliver, P. J., Martin, B. R., Mallouk, T. E., Chizhik, S. A., Buzaneva, E. V., Gorchinskiy, A. D., Chem. Mater. 1999, 11, 771-778
[3] Stankovich, S., Piner, R. D., Nguyen, R. S., Ruoff, R. S., Carbon 2006, 44, 3342-3347.
[4] Stankovich, S. et al. Nature 2006, 442, 282-286,
[5] Nielson, L. E., J. Macromol. Sci., Part A: Pure Appl. Chem. 1967, 1, 929-942.
[6] Choudalakis, A. D., et al., Eur. Polym. J., 2009, 45, 967-984.
[7] Yeh, J.-M. et al. Surf Coat. Technol. 2006, 200, 2753-2763.
[8] Cussler, E. L, et al. J. Membr. Sci., 1988, 38, 161-174

1. A composite film or layer comprising a polymer matrix and graphene nanosheets dispersed in the polymer matrix in an amount to reduce gas permeation through the film or layer.

2. The film or layer of claim 1 wherein individual graphene nanosheets are dispersed in the polymer matrix.

3. The film or layer of claim 1 wherein individual graphene nanosheets have a thickness dimension of about 1 nm.

4. The film or layer of claim 1 wherein the graphene nanosheets are present in an amount of about 0.01 volume % to 40 volume %.

5. The film or layer of claim 1 wherein the graphene nanosheets are surface-functionalized.

6. The film or layer of claim 5 wherein the graphene nanosheets are functionalized to express alkyl, substituted alkyl, phenyl, aryl, substituted phenyl, substituted aryl, and combinations of said moieties.

7. The film or layer of claim 1 wherein the polymer matrix is selected from the group consisting of polystyrene, polyacrylates, polyolefins, functionalized polyolefins (such as poly(vinyl chloride), poly(vinyl acetate), poly(vinyl alcohol), polyacrylonitriles), polyesters, polyurethanes, and polyethers.

8. The film or layer of claim 1 having a thickness of about 0.1 mm to about 50 mm.

9. A packaging film or layer for perishable goods or products, comprising a polymer matrix and graphene nanosheets dispersed in the polymer matrix in an amount to reduce gas permeation through the film or layer.

10. The film or layer of claim 9 wherein individual graphene nanosheets are dispersed in the polymer matrix.

11. The film or layer of claim 9 wherein individual graphene nanosheets or stacks of nanosheets have a thickness dimension of about 0.4 to about 1 nm.

12. The film or layer of claim 9 wherein the graphene nanosheets are present in an amount of about 0.01 volume % to 40 volume %.

13. The film or layer of claim 9 wherein the graphene nanosheets are surface-functionalized.

14. The film or layer of claim 13 wherein the graphene nanosheets are functionalized to express alkyl, substituted alkyl, phenyl, aryl, substituted phenyl, substituted aryl, and combinations of said moieties.

15. The film or layer of claim 9 wherein the polymer matrix is selected from a polymer selected from the group consisting of polystyrene, polyacrylates, polyolefins, functionalized polyolefins (such as poly(vinyl chloride), poly(vinyl acetate), poly(vinyl alcohol), polyacrylonitriles), polyesters, polyurethanes, and polyethers.

16. The film or layer of claim 9 having a thickness of about 0.1 mm to about 50 mm.

17. A method of reducing gas permeation of a polymer film or layer, comprising including graphene nanosheets in the polymer in an amount to reduce gas permeation through the film or layer of the resulting composite.

18. The method of claim 17 wherein individual graphene nanosheets are dispersed in the polymer matrix.

19. The method of claim 17 wherein individual graphene nanosheets or stacks of nanosheets have a thickness dimension of about 0.4 to about 1 nm.

20. The method of claim 17 wherein the graphene nanosheets are included in an amount of about 0.01 volume % to 40 volume %.

21. The method of claim 17 wherein the graphene nanosheets are surface-functionalized.

22. The film or layer of claim 17 wherein the graphene nanosheets are functionalized to express alkyl, substituted alkyl, phenyl, aryl, substituted phenyl, substituted aryl, and combinations of said moieties.

23. The method of claim 17 wherein the polymer matrix is selected from a polymer selected from the group consisting of polystyrene, polyacrylates, polyolefins, functionalized polyolefins (such as poly(vinyl chloride), poly(vinyl acetate), poly(vinyl alcohol), polyacrylonitriles), polyesters, polyurethanes, and polyethers.

24. The method of claim 17 wherein the film or layer is formed having a thickness of about 0.1 mm to about 50 mm.
